(19) United States
(12) Patent Application Publication
(10) Pub. No.: US 2014/0184014 A1
(43) Pub. Date: Jul. 3, 2014

(54) STATOR BOBBIN FOR DRIVE MOTOR

(71) Applicant: HYUNDAI MOTOR COMPANY, Seoul (KR)

(72) Inventors: Jung Shik KIM, Seoul (KR); Myeong Kyu JUNG, Seoul (KR); Young Jin SEO, Yongin-si (KR); Dongyeon HAN, Seoul (KR); Hyoungjun CHO, Seoul (KR); Kyoungbum KIM, Seongnam-si (KR); Sanghoon MOON, Seongnam-si (KR)

(73) Assignee: HYUNDAI MOTOR COMPANY, Seoul (KR)

(21) Appl. No.: 14/104,973

(22) Filed: Dec. 12, 2013

(30) Foreign Application Priority Data
Dec. 28, 2012 (KR) 10-2012-0157471

(51) Int. Cl. H02K 3/34

(52) U.S. Cl. CPC H02K 3/345
USPC 310/215

(57) ABSTRACT

In a stator bobbin for a drive motor, a bobbin body is coupled to a stator core divided into a number of sections across an entire area of the stator, and a coil is wound on the bobbin body. The trailing portion of the coil wound on the bobbin body is fixed to a fixing slot formed at one side of the bobbin body.

### CROSS-REFERENCE TO RELATED APPLICATION

This application claims the benefit of priority to Korean Patent Application No. 10-201 2-0157471 filed in the Korean Intellectual Property Office on Dec. 28, 2012, the entire contents of which are incorporated herein by reference.

### TECHNICAL FIELD

The present disclosure relates to a drive motor, and more particularly to a stator bobbin structure for a drive motor to improve a winding space factor of a coil.

### BACKGROUND

In general, hybrid vehicles or electric cars, so-called “environmentally-friendly cars,” are driven by an electric motor (hereinafter, referred to as a “drive motor”) which generates a torque from electrical energy.

Hybrid vehicles run in either EV (Electric Vehicle) mode, a pure electric car mode that uses only power of a drive motor, or in HEV (Hybrid Electric Vehicle) mode using a torque from both an internal combustion engine and the drive motor. A typical electric car runs by using a torque of the drive motor.

The drive motor used as a power source of the vehicle includes a stator and a rotor. The stator is coupled with a motor housing, and the rotor is disposed inside the stator.

An example of the drive motor employed in hybrid vehicles may include an annular concentrated winding drive motor, in which a stator core is divided into a plurality of sections in a circumferential direction, and an annular coil is concentratedly wound on the divided stator core parts to increase an output as well as torque density and to provide a high output power.

The stator of the annular concentrated winding drive motor can be configured by coupling the stator core, which is divided into a number of sections across the entire area of the stator, in the circumferential direction. A bobbin made of an insulating material is coupled to the stator core, and a high-tension coil is wound on the bobbin in a concentrated winding form.

The drive motor for a hybrid vehicle is designed to be as thin as possible to meet severe spatial restrictions. Having said that, it is important to wind the coil as many times as possible on the stator core, and make the space factor (which is a ratio of a cross-sectional area of a copper wire to a cross-sectional area of a space in which the copper wire is contained) as high as possible in the same space.

The performance of the drive motor is determined by torque density, output density, and efficiency. To this end, research is being conducted to increase the winding space factor of the stator. An increase in winding space factor may contribute to an efficiency enhancement while maintaining the torque density and output density. Therefore, persons in the art are making their efforts to enhance the space factor of a coil, such as reducing a thickness of an insulation coating of the coil and introducing a rectangular winding equipment.

FIG. 1 is a view schematically showing a stator bobbin structure for an annular concentrated winding drive motor according to the conventional art.

Referring to FIG. 1, in a stator bobbin structure 200 for an annular concentrated winding drive motor according to the conventional art, a bobbin 3 is coupled to a stator core 1, and a coil 5 is wound on the bobbin 3 in a concentrated winding form.

As the coil 5 is wound on the bobbin 3, a trailing portion of the coil passes through a main fixing slot 7 formed downward in an upper center part of the bobbin 3, and is fixed to a sub fixing slot 9 adjacent to the main fixing slot 7.

In the conventional art, the trailing portion of the coil 5 wound on the bobbin 3 is fixed to the main fixing slot 7 and the sub fixing slot 9 in an upper end of the winding.

In the conventional art, however, the trailing portion of the coil 5 is fixed to the main fixing slot 7 and the sub fixing slot 9 in an upper end of the bobbin 3, when the outer and inner diameters of the bobbin 3 are limited due to a narrow package space in vehicles. Thus, the winding of the coil 5 is not as high as the main fixing slot 7 in the upper end of the bobbin 3, which leads to a reduction of the winding space factor of the coil 5.

In the annular concentrated winding drive motor, the upper and lower ends of the winding have a greater height than sides of the winding because the coil 3 bulges when wound on the bobbin 3, and the winding of the coil 5 cannot cover the entire height of the main fixing slot 7 in the upper end of the bobbin 3.

Accordingly, in the conventional art, since the trailing portion of the coil 5 is fixed to the main fixing slot 7 in the upper end of the bobbin 3, the winding space factor of the coil is reduced, and therefore the torque density, output density, and efficiency of the drive motor may be deteriorated.

The above information disclosed in this background section is only for enhancement of understanding of the background of the inventive concept and therefore it may contain information that does not form the prior art that is already known in this country to a person of ordinary skill in the art.

### SUMMARY

The present disclosure has been made in an effort to provide a stator bobbin for a drive motor to improve a winding space factor of a coil by fixing a trailing portion of a coil to a side part of the bobbin in an upper end of the winding, rather than by fixing the trailing portion of the coil to an upper end of the bobbin.

An exemplary embodiment of the present disclosure provides a stator bobbin for a drive motor, in which a bobbin body is coupled to a stator core which is divided into a number of sections across an entire area of the stator, and a coil is wound on the bobbin body, wherein the trailing portion of the coil wound on the bobbin body may be fixed to a fixing slot formed at one side of the bobbin body.

The bobbin body may have the fixing slot formed at one side. The bobbin body may have a through slot formed at the other side, through which the coil passes.

The bobbin body may have a neck portion provided between the fixing slot and the through slot.

A leading portion of the coil may sequentially pass through the fixing slot, the neck portion, and the through slot.

The trailing portion of the coil may sequentially pass through the through slot, the neck portion, and the fixing slot.

The fixing slot may be formed at one side of the bobbin body on a boundary of an inner diameter portion and an outer diameter portion of the bobbin body.

The through slot may be formed at the other side of the bobbin body on the boundary of the inner diameter portion and the outer diameter portion of the bobbin body.

The fixing slot may have a length corresponding to a width of one side part of the bobbin body.

According to the exemplary embodiment of the present disclosure, the trailing portion of the coil wound on the bobbin body is fixed to the fixing slot formed at one side in an upper part of the bobbin body, the coil can be wound further on the bobbin body, compared to the conventional art. Therefore, the winding space factor of the coil can be increased, and hence the torque density, output density, and efficiency of the drive motor can be further improved.

Moreover, when redesigning the drive motor, the drive motor size can be reduced with increasing efficiency, and a reduced design can be applied to a permanent magnet.

Further, even when the space factor cannot be increased due to a full saturated height of the sides of the winding of the coil with respect to the bobbin body, a height of the bobbin body can be reduced since the trailing portion of the coil is fixed to the fixing slot at one side of the upper part of the bobbin body.

This decreases the total volume of the drive motor, and hence improves a degree of freedom of installation of the drive motor in a limited package space in vehicles. Further, the torque density and output density of the drive motor can be increased.

### BRIEF DESCRIPTION OF THE DRAWINGS

These drawings should not be construed as to limit the present disclosure, but are intended to be exemplary and for reference.

FIG. 1 is a view schematically showing a stator bobbin structure for an annular concentrated winding drive motor according to the conventional art.

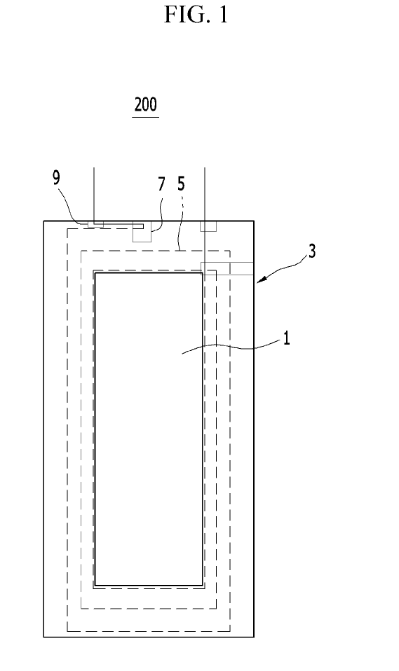

FIG. 2 is a front view showing a stator bobbin structure for a drive motor in accordance with an exemplary embodiment of the present disclosure.

FIG. 3 is a view schematically showing a coil winding structure of the stator bobbin for the drive motor in accordance with the exemplary embodiment of the present disclosure.

FIG. 4 is a view for explaining an operational effect of the stator bobbin for the drive motor in accordance with the exemplary embodiment of the present disclosure.

### DETAILED DESCRIPTION OF THE EMBODIMENTS

The present disclosure will be described more fully hereinafter with reference to the accompanying drawings, in which exemplary embodiments of the inventive concept are shown. As those skilled in the art would realize, the described embodiments may be modified in various different ways, all without departing from the spirit or scope of the present disclosure.

In order to clarify the present disclosure, parts which are not connected with the description will be omitted, and the same or similar elements are referred to by the same reference numerals throughout the specification.

Further, the sizes and thicknesses of the elements shown in the drawings are arbitrarily shown for convenience of description, and thus embodiments are not limited to those illustrated. In the drawings, thicknesses are magnified in order to clearly depict a plurality of parts and regions.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element.

Throughout the specification, unless explicitly described to the contrary, the word “comprise” and variations such as “comprises” or “comprising”, will be understood to imply the inclusion of stated elements but not the exclusion of any other elements.

Further, the terminologies described in the specification, such as “unit”, “means”, “part”, “member,” etc. refer to units performing at least one function or operation.

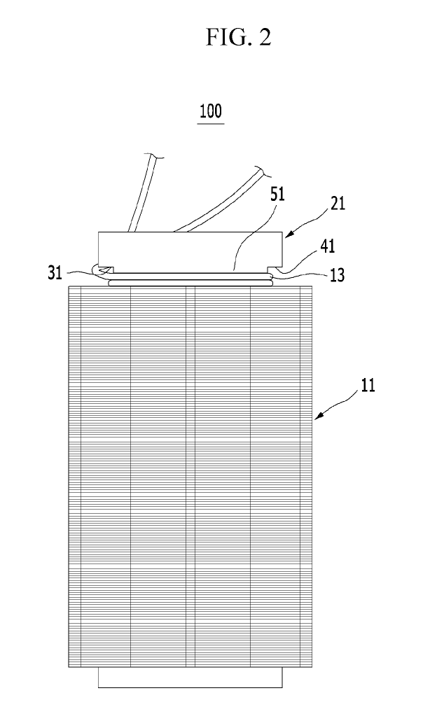

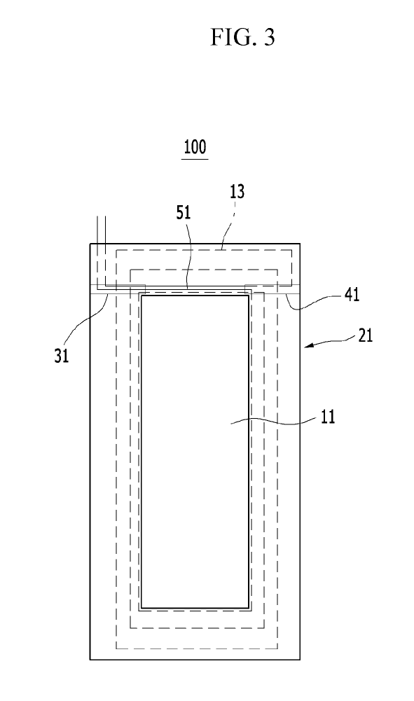

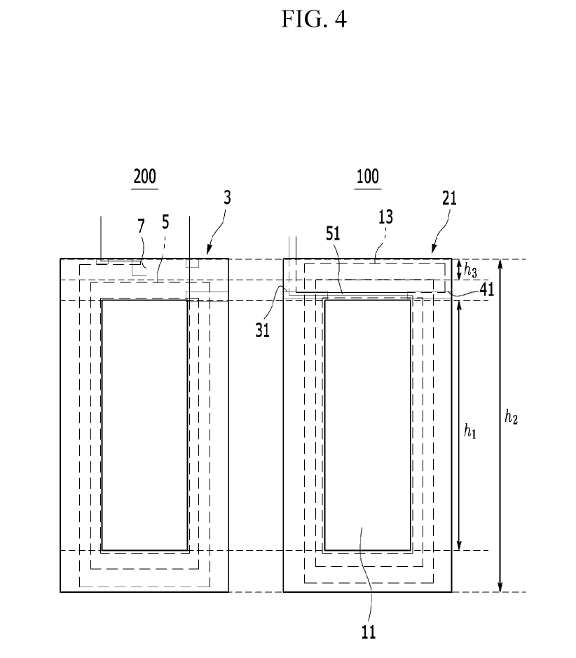

FIG. 2 is a front view showing a stator bobbin structure for a drive motor in accordance with an exemplary embodiment of the present disclosure. FIG. 3 is a view schematically showing a coil winding structure of the stator bobbin for the drive motor in accordance with an exemplary embodiment of the present disclosure. FIG. 4 is a view for explaining an operational effect of the stator bobbin for the drive motor in accordance with the exemplary embodiment of the present disclosure.

Referring to FIG. 2 and FIG. 3, in the stator bobbin 100 for the drive motor in accordance with the exemplary embodiment of the present disclosure, a stator core 11 is divided into a plurality of sections in a circumferential direction, and an annular coil 13 is concentratedly wound on the divided sections of the stator core 11, to increase an output density and torque density of the drive motor and provide a high output power.

An annular concentrated winding drive motor includes a bobbin body 21 to be coupled to the stator core 11. The annular coil 13 (hereinafter, referred to as “coil” for convenience) is concentratedly wound on the bobbin body 21.

The bobbin body 21 is made of an insulating material, and, as shown in FIG. 4, may have an inner diameter portion h1 having the same height as the stator core 11 and an outer diameter portion h2 having a greater height than the inner diameter portion h1, and be coupled to the stator core 11.

In the following description, referring to FIG. 4, an upper part of the bobbin body 21 may be defined by a portion above an upper boundary of the inner diameter portion h1 and the outer diameter portion h2, and a lower part of the bobbin body 21 may be defined by a portion below a lower boundary of the inner diameter portion h1 and the outer diameter portion h2.

Moreover, sides of the bobbin body 21 to be mentioned below may be defined by both side parts located on both sides of the stator core 11 between the upper part and the lower part.

However, a direction of orientation as used herein is relative only, and can be changed depending on the position of the stator core 11 relative to the drawings. Accordingly, this direction of orientation is not limited to this exemplary embodiment.

The stator bobbin 100 for the drive motor in accordance with the exemplary embodiment of the present disclosure to substantially improve a winding space factor of the coil 13 by fixing a trailing portion of the coil 13 to a side part of the bobbin body 21 in an upper end of the winding, rather than by fixing the trailing portion of the coil 13 to an upper end of the bobbin body 21.

Referring to FIG. 2, the stator bobbin 100 for the drive motor in accordance with the exemplary embodiment of the present disclosure has a basic structure in which the bobbin 21 is coupled to the stator core 11, which is divided into a number of sections across the entire area of the stator, and the coil 13 is wound on the bobbin body 21.

In the basic structure of the stator bobbin, the trailing portion of the coil 13 wound on the bobbin 21 may be fixed to a fixing slot 31 formed at one side in the upper part of the bobbin body 21.

That is, the fixing slot 31 is formed at one side of the upper part of the bobbin body 21. In this case, a through slot 41 through which the coil 13 passes is formed at the other side of the upper part of the bobbin body 21 to correspond to the fixing slot 31.

As the fixing slot 31 is formed at one side of the upper part of the bobbin body 21, and the through slot 41 is formed at the other side of the upper part thereof, as described above, a neck portion 51 is provided between the fixing slot 31 and the through slot 41 to allow the coil 13 to pass therethrough as the coil 13 is wound.

As such, the leading portion of the coil 13 sequentially passes through the fixing slot 31, the neck portion 51, and the through slot 41, and the trailing portion of the coil 13 sequentially passes through the through slot 41, the neck portion 51, and the fixing slot 31.

In this case, the fixing slot 31 may be formed at one side of the bobbin body 21 on the upper boundary of the inner diameter portion h1 and outer diameter portion h2 of the bobbin body 21. The through slot 41 may be formed at the other side of the bobbin body on the upper boundary of the inner diameter portion h1 and outer diameter portion h2 of the bobbin body 21.

For example, the fixing slot 31 may have a length corresponding to a width of one side of the bobbin body 21.

In the stator bobbin 100 for the drive motor in accordance with the exemplary embodiment of the present disclosure, as shown in FIG. 4, the trailing portion of the coil 13 wound on the bobbin body 21 may be fixed to the fixing slot 31 formed at one side in the upper part of the bobbin body 21.

When winding the coil 13 on the bobbin body 21, the leading portion of the coil 13 sequentially passes through the fixing slot 31, the neck portion 51, and the through slot 41, and the trailing portion of the coil 13 sequentially passes through the through slot 41, the neck portion 51, and the fixing slot 31.

A comparison between the stator bobbin structure 100 in accordance with the exemplary embodiment of the present disclosure and the stator bobbin structure 200 according to the conventional art will be described with reference to FIG. 4. In the conventional art of the stator bobbin 200, the trailing portion of the coil 5 wound on the bobbin 3 is fixed to the main fixing slot 7 formed in an upper center part of the bobbin 3.

On the other hand, in the exemplary embodiment of the present disclosure, the trailing portion of the coil 13 wound on the bobbin body 21 is fixed to the fixing slot 31 formed at one side in the upper part of the bobbin body 21. Thus, the coil 13 can be wound further on the bobbin body 21 to cover a height difference h3 between the conventional main fixing slot 7 and the fixing slot 31 of this exemplary embodiment.

As such, the trailing portion of the coil 5 can be fixed to the fixing slot 31 in the upper part of the bobbin body, when a space between the inner diameter portion h1 and the outer diameter portion h2 of the bobbin body 21 is limited, thereby increasing the winding space factor of the coil 13.

Accordingly, the exemplary embodiment of the present disclosure can increase the winding space factor of the coil 13, compared to the conventional art, thereby further improving the torque density, output density, and efficiency of the drive motor.

In the exemplary embodiment of the present disclosure, test and simulation results show that the winding space factor of the coil 13 is increased by 5% (from 45.5% to 50.5%), and a winding resistance of the coil 13 is decreased by 10% (from 14.0% to 12.6%). Hence, a copper loss is decreased by a decrease of winding space factor, and efficiency in a driving area is improved by up to 1%.

Therefore, when redesigning the drive motor in the exemplary embodiment of the present disclosure, the drive motor size can be reduced with an increased efficiency and a reduced design can be applied to a permanent magnet.

Moreover, even when the space factor cannot be increased due to a full saturated height of the sides of the winding of the coil 13 with respect to the bobbin body 21, the height of the bobbin body 21 can be reduced by the height difference h3, between the main fixing slot 7 and the fixing slot 31 according to the conventional art and the fixing slot 31 of this exemplary embodiment.

The total volume of the drive motor can be decreased, and a degree of freedom of installation of the drive motor in a limited package space in vehicles can be improved. Further, the torque density and output density of the drive motor can be increased.

While this inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A stator bobbin for a drive motor, including:
a bobbin body coupled to a stator core divided into a number of sections across an entire area of the stator; and
a coil is wound on the bobbin body,
wherein a trailing portion of the coil wound on the bobbin body is fixed to a fixing slot formed at one side of the bobbin body.

2. The stator bobbin of claim 1, wherein the bobbin body has the fixing slot formed at one side and a through slot formed at the other side, through which the coil passes.

3. The stator bobbin of claim 2, wherein the bobbin body has a neck portion disposed between the fixing slot and the through slot.

4. The stator bobbin of claim 3, wherein
a leading portion of the coil sequentially passes through the fixing slot, the neck portion, and the through slot, and
the trailing portion of the coil sequentially passes through the through slot, the neck portion, and the fixing slot.

5. The stator bobbin of claim 2, wherein the fixing slot is formed at one side of the bobbin body on the boundary of an inner diameter portion and an outer diameter portion of the bobbin body.

6. The stator bobbin of claim 5, wherein the through slot is formed at the other side of the bobbin body on the boundary of the inner diameter portion and outer diameter portion of the bobbin body.

7. The stator bobbin of claim 5, wherein the fixing slot has a length corresponding to a width of one side part of the bobbin body
